(19) United States
(12) Patent Application Publication
(10) Pub. No.: US 2025/0156495 A1
(43) Pub. Date: May 15, 2025

(54) METHODS AND DEVICES OF FILE DISTRIBUTION IN WIRELESS NETWORKS

(71) Applicant: Morse Micro Pty. Ltd., Surry Hills NSW (AU)

(72) Inventors: Richard Kinder Kinder, Surry Hills NSW (AU); Matthew Jervis, Surry Hills NSW (AU)

(21) Appl. No.: 18/919,308

(22) Filed: Oct. 17, 2024

(30) Foreign Application Priority Data
Nov. 14, 2023 (AU) 2023903659

(51) Int. Cl. G06F 16/955; G06F 16/951; H04L 47/43; H04W 28/06

(52) U.S. Cl. CPC G06F 16/955; G06F 16/951; H04L 47/43; H04W 28/06

(57) ABSTRACT

Systems and techniques are provided for file distribution. A wireless communication device determines an update ID of an update package, segments the update package into chunks, includes the chunks and update ID in predetermined management frames, and transmits the predetermined management frames to multiple devices wirelessly connected to the wireless communication device. An exemplary update package contains a file and metadata, or a firmware update binary file. In some other embodiments, a wireless communication device receives predetermined management frames, determines an update ID of the update package from the predetermined management frames, extracts chunks of the update package from the predetermined management frames, stores the chunks in a chunk buffer, and constructs the update package from the chunks. Some embodiments of the wireless communication device request one or more missing chunks by sending a frame and receive the missing chunk via direct transmission or broadcasting.

### CROSS-REFERENCE TO RELATED APPLICATIONS

This application claims the benefit of Australian Provisional Patent Application No. 2023903659, filed Nov. 14, 2023, and entitled “METHODS AND DEVICES OF FILE DISTRIBUTION IN WIRELESS NETWORKS,” which is hereby incorporated by reference, in its entirety and for all purposes

### FIELD

The present disclosure generally relates to wireless communications. Aspects of the present disclosure are related to file distribution or firmware update in a wireless network.

### BACKGROUND

File distribution such as firmware update for a modern embedded system can be delivered through a wireless network. The wireless network, such as an IEEE 802.11 based Wireless Local Area Network (WLAN), is formed by one or more Access Points (APs) that provide a shared wireless medium for use by a number of stations (STAs). The AP enables the STA to communicate bi-directionally with the AP and/or enables a STA to communicate with other STAs. The AP also allows all its associated STAs to become connected to a wired or wireless communication network such as the Internet. Prior to connecting to a particular wireless network, a STA sends an association request to an AP in the wireless network. The association request received by the AP is used by the AP to check the validity of the STA, for example, by verifying the Service Set Identifier (SSID) of the STA. The AP subsequently permits or denies the association request accordingly. Some examples of the embedded system include mobile devices, automobiles, Internet of Things (IoT) devices, and telecommunication equipment. The operating system, applications, configuration settings, or parameters of these embedded systems can be updated without conventional direct physical access or wired connections. A remote firmware distribution tool which updates devices over the air allows managing multiple devices remotely and effortlessly. However, there are security concerns for the remote file distribution and firmware update as the devices may be open to attack from unauthorized third parties. File distribution and firmware updates must be delivered in a timely and systematic manner, otherwise devices in the fleet will be open to software vulnerabilities which increase the threat vectors for these devices. A secure communication channel needs to be established between the server and the embedded system for the embedded system to receive the required update. The gateway or microcontroller of the embedded system often receives updated firmware codes through proxy. The current firmware codes of the embedded system are replaced by the updated firmware codes if the received firmware codes can be successfully authenticated.

A conventional firmware update process can be done in a seamless way, by having two copies of all essential partitions. Each set of partitions is referred to as a slot. At any given time, only a single slot is considered active. The device downloads the update file and installs the update to the inactive slot, and the next time the device is rebooted, it reboots into the update slot, thus completing the update seamlessly. Alternatively, devices set up for traditional updates must be offline while applying the update as they only have one set of partitions. The firmware codes also include a recovery partition that is required to install updates to the main system partition.

Firmware updates are often needed to add features, upgrade system versions, patch security vulnerabilities, or fix software bugs. Firmware update files are designed to be as small as possible to minimize the power consumption, network usage, and storage space, which can be achieved by only transferring differences between old firmware codes and new firmware codes, rather than transmitting the entire new firmware codes.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing file distribution over a wireless communication network such as a Wireless Local Area Network (WLAN). According to at least one illustrative example, a method of file distribution over a wireless communication network is provided, which comprises a method for distributing an update package to multiple devices wirelessly connected in the network. Firmware update over the air is an example of file distribution in the wireless communication network. For example, the file distribution method is executed by an Access Point (AP) and the multiple devices are stations (STAs) associated with the AP in the wireless communication network. The method comprises determining an update ID of the update package, segmenting the update package into chunks, including the chunks and update ID in predetermined management frames, and broadcasting the predetermined management frames to multiple devices. In some embodiments, the update package comprises a file and metadata, and in some other embodiments, the update package comprises a firmware update binary file. The metadata includes a byte sequence used to uniquely identify a type of device receiving the update package according to an embodiment. The metadata includes a version number of the file according to an embodiment. In some embodiments, the metadata includes the update ID of the update package, where the update ID is unique for a group of devices and is unique for each update package. The metadata may also include information about how often a chunk of the update package is inserted into the predetermined management frame. For example, at least a portion of the metadata is inserted in every Nth predetermined management frame, where N is a positive integer. In an embodiment, the metadata comprises a globally unique identifier for the update package that is synchronized across multiple networks, to allow a device moving between networks to resume the update package.

In one aspect, the file distribution method further comprises calculating a signature using an algorithm across at least a portion of the update package, including the signature in the update package, and transmitting the signature using one or more predetermined management frames or transmitting the signature independently through a frame. The signature is used to verify the contents of the update package.

Some embodiments of the file distribution method further comprise assigning each chunk with a chunk offset representing an offset of the chunk within the update package and packaging each chunk to include a header to generate a packaged chunk (pchunk). The header may include the chunk offset and the update ID.

In some aspects of the present invention, the file distribution method further generates an update advertisement for the update package, where the update advertisement is composed of one or a combination of the update ID, a device identifier, a firmware version and a file length. An embodiment of including the chunks in the predetermined management frames further comprises generating a vendor IE packaged chunk (vpchunk) for a chunk by inserting the update advertisement and the chunk in a vendor Information Element (IE) of a predetermined management frame or inserting only the chunk in a vendor IE of the predetermined management frame.

The predetermined management frame is a beacon frame according to some embodiments, and in some embodiments, the predetermined management frame can only be a Delivery Traffic Indication Message (DTIM) beacon frame. In some embodiments, the devices in the wireless network have different device types and the update package may be distributed to each device type using different predetermined management frames. For example, the update package distributed to device type 1 is different from the one distributed to device type 2. In this example, the method comprises transmitting one or more chunks of the update package to device type 1 in every Nth predetermined management frame and transmitting one or more chunks of the update package to device type 2 in every Nth+1 predetermined management frame, where N is a positive integer. The scheduling for transmitting the update package to each device type may be different, for example, the interval or frequency of transmitting the chunk of the update package for each device type can be selected depending on the device type.

Embodiments of the file distribution method may include a scheme accepting retransmission requests and scheduling retransmission of missing chunks. For example, the file distribution method includes receiving a frame indicating one or more missing chunks of the update package from a STA in the wireless network, packaging up the one or more missing chunks in an action management frame, and transmitting the action management frame to the STA. Alternatively, the file distribution method includes receiving at least a frame indicating one or more missing chunks of the update package from one or more STAs and rebroadcasting the one or more missing chunks to the STAs in the wireless network. In one embodiment, the file distribution method includes receiving a plurality of frames from STAs, each frame indicating one or more missing chunks of the update package, directly transmitting one or more missing chunks using one or more action management frames to one or more STAs and rebroadcasting one or more missing chunks to the STAs in the wireless network.

In an embodiment of the present invention, the file distribution method comprises broadcasting a frame with a flag set indicating requesting missing chunks is allowed, and receiving one or more frames indicating one or more missing chunks of the update package from one or more STA in the wireless network.

In some aspects of the present invention, a wireless communication device operating in a wireless network includes a Radio Frequency (RF) receiver, an RF transmitter, a processor, and one or more memory banks storing processor readable codes. An example of the wireless communication device is an AP. The wireless communication device determines an update ID of an update package to be distributed to devices in the wireless network, segments the update package into chunks, includes the chunks and the update ID in predetermined management frames, and transmits the predetermined management frames to distribute the update package in the wireless network.

Some aspects of the present invention are related to methods for receiving and constructing the update package. For example, the methods are executed by a station wirelessly connected to an AP in a wireless network, where the AP is the distributor of the update package. In some embodiments, the method for receiving an update package distributed in a wireless network comprises wireless receiving predetermined management frames, determining an update ID of the update package from at least one of the predetermined management frames, extracting chunks of the update package from the predetermined management frames, storing the chunks, and constructing the update package from the chunks.

In some embodiments, one or more of the predetermined management frames comprise an update advertisement of the update package. The update advertisement comprises one or a combination of update ID, a device type identifier, a firmware version, and a length of the update package. In one embodiment, the device type identifier in the update advertisement is compared with a specific value, and in one embodiment, the firmware version in the update advertisement is compared with a current firmware version. Depending on a comparison result of the firmware version in the update advertisement, the method further includes resetting an in-progress reception state and restarting reception of the update package.

In one aspect of storing chunks of the update package for construction, the method comprises checking a chunk offset of a chunk and storing the chunk according to the chunk offset. In some aspects, a signature of the update package is determined for verifying contents of the update package, and a firmware update is scheduled when the update package is completely received and the content is successfully verified.

The method further comprises checking for any missing chunk of the update package received from the distributor and requesting the missing chunk by transmitting a frame to the distributor according to some embodiments. In one embodiment, the step of requesting one or more missing chunks is performed only after receiving a frame with a flag set indicating requesting missing chunks is allowed. Some examples of the frame with a flag set indicating requesting missing chunks is allowed is a directed action management frame, a broadcast action management frame, a directed data frame, or a broadcast data frame sent by the AP in the wireless network.

In some aspects of the present invention, a wireless communication device, for example, a STA in a wireless network, comprises an RF receiver, an RF transmitter, a processor, and one or more memory banks storing processor readable codes. The wireless communication device is configured to wirelessly receive multiple predetermined management frames, determine an update ID of the update package from at least one of the predetermined management frames, extract chunks of the update package from the predetermine management frames, store the chunks in a chunk buffer, and construct the update package from the chunks.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following drawing figures:

FIG. 1 illustrates an embodiment of segmenting an update package into chunks and packaging each chunk into a beacon frame for transmission.

FIG. 2A illustrates an embodiment of transmitting chunks of an update package by beacon frames and periodically incorporating an update advertisement in selective beacon frames.

FIG. 2B illustrates an embodiment of distributing a new update package after broadcasting several chunks of an original update package by beacon frames.

FIG. 3 illustrates receiving beacon frames carrying chunks of an update package, extracting and storing the chunks in a chunk buffer according to an embodiment of the present invention.

FIG. 4 illustrates an embodiment of receiving chunks of an update package through beacon frames with two missing chunks.

FIG. 5 illustrates an embodiment of STAs requesting missing chunks by sending action management frames to an AP and receiving these missing chunks through directed action management frame and broadcasted beacon frames.

FIG. 6 is a flow diagram of a file distribution method for transmitting an update package through predetermined management frames in accordance with an embodiment of the present invention.

FIG. 7 is a flow diagram of a file distribution method for transmitting an update package through predetermined management frames in accordance with another embodiment of the present invention.

FIG. 8 is a flow diagram of a file distribution method for receiving and reconstructing an update package in accordance with an embodiment of the present invention.

FIG. 9 is a flow diagram of a file distribution method for receiving and reconstructing an update package with a mechanism to request missing chunks in accordance with an embodiment of the present invention.

FIG. 10 is a block diagram illustrating an example of a communication system for implementing certain aspects described herein, in accordance with some embodiments.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Embodiments of the present invention provide a method and device of file distribution through predetermined management frames that is built on top of the IEEE 802.11 standards. The file distribution method achieves power and airtime efficient file transferring or firmware updating. Embodiments of the file distribution method is particularly beneficial for large networks, which presents both an airtime and power efficiency boost above traditional remote firmware update methods of unicasting or broadcasting firmware updates through regular Internet Protocol (IP) based network connections.

In some embodiments of the present invention, a wireless network consisting of one or more AP and multiple STAs, where each STA runs the firmware codes that define the functionality and operation of the STA. The STA is a general term used in the following description to represent a device receiving a file or firmware update distributed by the AP in the wireless network. The AP, on the other hand, is a general term used in the following description to represent a distributor transmitting the file or firmware update to one or more devices in the wireless network. The firmware codes executed by the processor(s) of the STA are typically updated from time-to-time, which involves overwriting the flash storage containing the currently running firmware codes with the new firmware codes. Alternatively, the STA maintains two copies of the firmware codes, an active copy that is currently executing and an update copy that is being updated, and on successful update, the roles are switched. In another embodiment, the two copies of firmware codes include a live updated version and a factory version to recover in case of failure. Embodiments of the file distribution method can be applied to any format of device flash layout and image contents used by the end device. Embodiments of the wireless network include IEEE 802.11 based networks, and embodiments of the STAs include low powered IoT stations and more capable STAs such as laptops and phones. For example, the wireless network consists of a single IEEE 802.11ah standard compliant AP and a large number of IEEE 802.11ah standard compliant STA IoT sensor devices. In some other examples, the wireless network consists of multiple IEEE 802.11b/g/n/ah/ac/ax standard compliant APs, multiple IEEE 802.11ah standard compliant STA IoT sensor devices, multiple IEEE 802.11b/g/n standard complaint STAs including both sensor and more functional devices, and multiple IEEE 802.11ac/ax standard compliant STA, including both sensor and more functional devices. Theoretically, an IEEE 802.11ah AP can support up to 8191 stations. A person skilled in the art understands that the form of both AP and STA devices can take any form and run on any IEEE 802.11 protocol version(s). In some embodiments of the present invention, a given STA may be a member of a single network or may move between multiple networks. The STAs in a given network may require different firmware codes, this may be due to the devices being of different device types. In some embodiments, the firmware codes running on the STAs are a binary computer readable set of instructions, generated by the STA device vendor. For example, the firmware binary file is 200 KB (Kilo Bytes) in size.

In some embodiments, the file to be pushed to STAs in a wireless network may be accompanied by metadata that describes the file. The file is a firmware update binary file or any other data file. The file and accompanying metadata or the file itself in this patent specification is referred to as an update package. An embodiment of the accompanying metadata includes important information that a device needs to decide whether it should take an update, for example, the information includes the device type that is being updated and a version number. In one embodiment, the metadata includes a globally unique identifier for the firmware update that is synchronized across multiple networks, a device that moves between networks can resume the previously in progress update using management frames, such as beacon frames, on that network. In some other embodiments, the update package only contains the file, for example, the update package only contains the firmware update binary file. In yet another embodiment, the update package contains a file that needs to be pushed to multiple STAs in the wireless network. The update package can take many forms and other forms of the update package have been omitted here for brevity.

An update package may be pushed to the AP from one or more vendor servers through some means. In some embodiments, an Internet protocol, such as the Message Queue Telemetry Transport (MQTT) protocol, is used to transfer the update package from the vendor server to the AP. The MQTT protocol is a machine-to-machine network protocol for message queue service. In another embodiment, a secure file copy (scp) is initiated to transfer the update package from the vendor server to the AP. In some embodiments, an update package is pushed to multiple networks using one or more predetermined protocols.

Some embodiments of the file transfer or firmware update method convey an update package from an AP to multiple STAs in the wireless network. The update package includes a firmware update binary file or any kind of file to be distributed to multiple devices. In one embodiment, the software program running on the AP performs operations on the update package to allocate an update identifier (ID) to the update package and calculate a signature using an algorithm across at least a portion of the update package in order to provide a method for verifying the content of the update package by the STA. In some embodiments, the update identifier must not be already in use by an ongoing update and should not have been used by a recent update. This update identifier is used to differentiate different updates which may be running in parallel on a single wireless network. For example, the update identifier is 3 bits wide or 8 bits wide. Some examples of the algorithm for computing the signature based on at least a portion of the update package are HMAC-SHA256, md5, SHA256. In various different embodiments, this hash signature may be inline as part of the embedded firmware binary in the update package or may be communicated independently through a mechanism such as transmission in an action management frame. In another embodiment, the signature is computed at an earlier stage in the process and is provided to the AP as part of the update package.

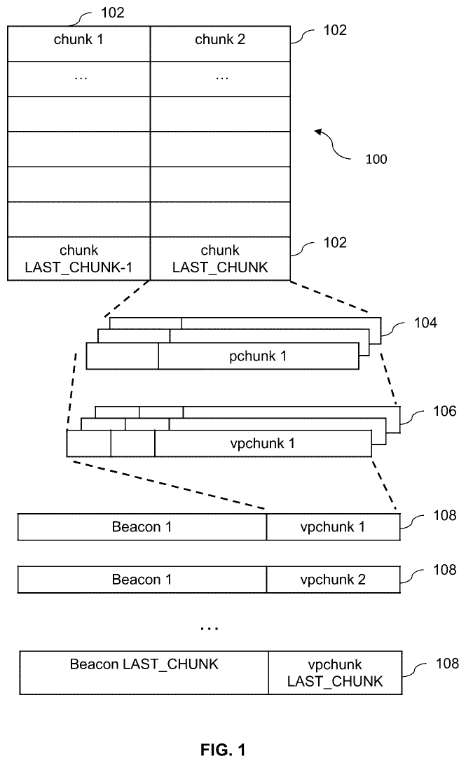

In some embodiments, a firmware binary image of the update package is segmented into equal-sized chunks. For example, the supported chunk sizes are 16, 32, 64, and 128 bytes in length. Each chunk is assigned a number from 1 through to LAST_CHUNK, where LAST_CHUNK can be derived by dividing the image size by the chunk size. The assigned number represents the offset of the given chunk within the firmware binary image. In one example, the chunks are assigned from 0 to LAST_CHUNK, where LAST_CHUNK is calculated by dividing the image size by the chunk size then subtracting 1. FIG. 1 illustrates an embodiment of segmenting a firmware binary image 100 of an update package into chunks and packaging each chunk into a beacon frame. The firmware binary image 100 is segmented into chunks with chunk number from 1 to LAST_CHUNK. Each of the chunks of the firmware binary image is packaged to include a header, which creates a packaged chunk, or ‘pchunk’ 102. The header of a pchunk may contain a chunk offset field, which may be in multiples of the chunk size, indicating which part of the reassembled firmware binary image the chunk belongs to. Some examples of the chunk offset field are 2 or 4 bytes in length. In one embodiment, the chunk offset field is two bytes in length which contains the following bitfields: bits 0 to 1 indicate the chunk size, for example, 0 refers to 16 bytes, 1 refers to 32 bytes, 2 refers to 64 bytes, and 3 refers to 128 bytes; bit 2 indicates whether a hash is contained in the chunk offset 0xFFFE; bits 3 to 5 are used to indicate an update identifier, which corresponds to the identifier allocated by the AP to the update package; and bits 5 to 15 are reserved. The packaged chunk 102 may also contain a chunk data field, and the length of this field is the chunk size. In some embodiments, a signature is computed using an algorithm such as HMAC-SHA256, md5, SHA256 across the contents of the pchunk 102, and a complete signature or a subset of the signature is added to the pchunk 102. In some other embodiments, there is no signature added to the pchunk 102. These pchunks 102 are then provided to the software program running on the AP which constructs management frames.

In some embodiments, the software program running on the AP inserts the chunks 100 or pchunks 102 into a circular buffer, initializes a memory pointer to point to the first element or maintains an index into the buffer. The AP constructs an IEEE compliant management frame by inserting the next chunk 100 or pchunk 102 from the circular buffer into a predetermined management frame, transmits or broadcast the predetermined management frame on the wireless network, and increments the circular buffer pointer or updates the index, repeating the process to transmit all chunks 100 or pchunks 102 of the firmware binary image. The software may maintain multiple circular buffers simultaneously. An update advertisement may be generated for the update package, and an embodiment of the update advertisement structure has the following fields: update identifier, device type identifier, firmware version, and file length. For example, the file length indicates the length of the firmware update file. The update identifier corresponds to the identifier allocated by the AP to the update package, and the file length can be in terms of number of chunks, length in bytes, or some other unit of measurement. Some other embodiments of the update advertisement structure may contain more or less fields. Some embodiments of the update advertisement also include information about how often chunks for this update identifier will be inserted into predetermined management frames. The beacon frame is an example of the predetermined management frame for conveying the chunk of the update package. The chunks of the update package may be included in all beacon frames, in all DTIM beacon frames, in selected beacon frames, or just in selected DTIM beacon frames. In some embodiments, the information carried in the update advertisement indicates an interval between beacon frames containing the chunks of the update package or the phase of the update. At the time of constructing the predetermined management frames, the update advertisement and chunks 100 or pchunks 102 of the update package are further processed. Some embodiments of processing the update advertisement and chunks/pchunks include inserting both the update advertisement and a chunk 100 or pchunk 102 or only inserting a chunk 100 or pchunk 102 into an IEEE 802.11 compliant vendor Information Element (IE) container to generate a vendor IE packaged chunk, vpchunk 104, followed by inserting the vpchunk 104 into the predetermined management frames 106 as shown in FIG. 1. The contents of the vendor IEs vary based on the application in use and based on the vendor-specific use of the given Organizationally Unique Identifier (OUI). In most cases, the vendor OUI is followed by a vendor IE specific type or subtype field or other fields to allow multiple functional uses of the vendor IE. In one embodiment of the present invention, the vendor-IE-specific type field is used to identify that the IE contains only a chunk 100 or pchunk 102 or that it also contains an update advertisement, and the subtype differentiates device types. In some embodiments, multiple chunks 100 or pchunks 102 may be concatenated in a single vpchunk 104, provided that the total length does not exceed the maximum IE length or the maximum supported management frame length.

In the embodiment as shown in FIG. 1, the predetermined management frame is a beacon frame, where inserting chunks 100, pchunks 102, or vpchunks 104 of an update package into beacon frames is also referred to as beacon stuffing. In an IEEE 802.11 WLAN, there are three frame categories: management, control, and data frames. Management frames are used for probing, associating, roaming, and disconnecting clients from the BSS. For example, the beacon frame is one of the management frames served to broadcast information about the capabilities and configuration of the network and to synchronize STAs with the AP. The AP periodically broadcasts a beacon frame to enable STAs within the range of the BSS to establish or maintain communication within the WLAN. The beacon frames are vital for operations of the IEEE 802.11 network which allows STAs to receive beacon frames from their currently associated AP and update the internal clock according to the timestamps carried in the beacon frames. The STAs may also scan Radio Frequency (RF) channels searching for beacon frames announcing the presence of nearby APs in order to allow the STA to connect to an alternative wireless network. In addition, the beacon frames also enable STAs to operate in power saving modes, specifically, the AP holds on to packets destined for STAs that are currently sleeping and uses a beacon frame to inform these STA that there is data traffic buffered by the AP and waiting for delivery. In another embodiment of the present invention, the predetermined management frame is an action management frame and a chunk 100, pchunk 102, or vpchunk 104 can be inserted after inserting all other IEs within the action management frame. In some other embodiments, one or more regular management frames such as a probe response, authentication or association response, and Extensible Authentication Protocol (EAP) key exchange packets can be used to carry chunks 100, pchunks 102, or vpchunks 104 of the update package. Some control frames such as Block acknowledgement (ACK) frames may also be used as the predetermined management frame for distributing the update package according to an embodiment. In one specific embodiment of distributing vpchunks 104 of an update package to multiple devices by a broadcast Action Management frame, a vpchunk IE is added to the end of a ‘20/40 BSS Coexistence Management’ Public Action Management frame. For example, the vpchunk IE is inserted after the 20/40 BSS Coexistence or 20/40 Intolerant Channel Report(s) elements. In another embodiment, the predetermined management frame is a Radio Measurement Action Management frame, where a slightly modified pchunk 102 can be piggybacked inside a Measurement Report element within the Radio Measurement Action Management frame. For example, setting the Measurement type field in a Radio Measurement Action Management frame to a predefined value indicates this Radio Measurement Action Management frame carries a chunk 100 or pchunk 102 of an update package.

In some embodiments of the present invention, chunks of an update package are stored in a circular buffer, and a circular buffer pointer is incremented by one element for each transmitted chunk 100 or pchunk 102. The circular buffer pointer cycles through all entries within the circular buffer. A complete cycle of transmitting chunks numbered 1 to LAST_CHUNK through the predetermined management or control frames may be repeated more than once, to provide redundancy for STAs which may miss receiving one or more predetermined management frames. In some embodiments of inserting chunks 100, pchunks 102, or vpchunks 104 in beacon frames, the beacon frames are transmitted at each Target Beacon Transmission Time (TBTT). Alternatively, the software program only populates the chunks 100, pchunks 102, or vpchunks 104 on each Delivery Traffic Indication Message (DTIM) beacon frame, which is a beacon frame including DTIM information. DTIM beacon frames advertise broadcast or multicast data to STAs, where all connected STAs may wake up to receive these DTIM beacon frames. In one specific embodiment of distributing a 1 Megabyte (MB) update package in an IEEE 802.11ah network, the update package is partitioned into 32 bytes chunks, and each 32 bytes chunk is transmitted by a DTIM beacon frame. With a standard beacon interval of 100 Tus and a DTIM period value of 10, it would take roughly 10 hours to complete the transmission of all chunks assuming no loss.

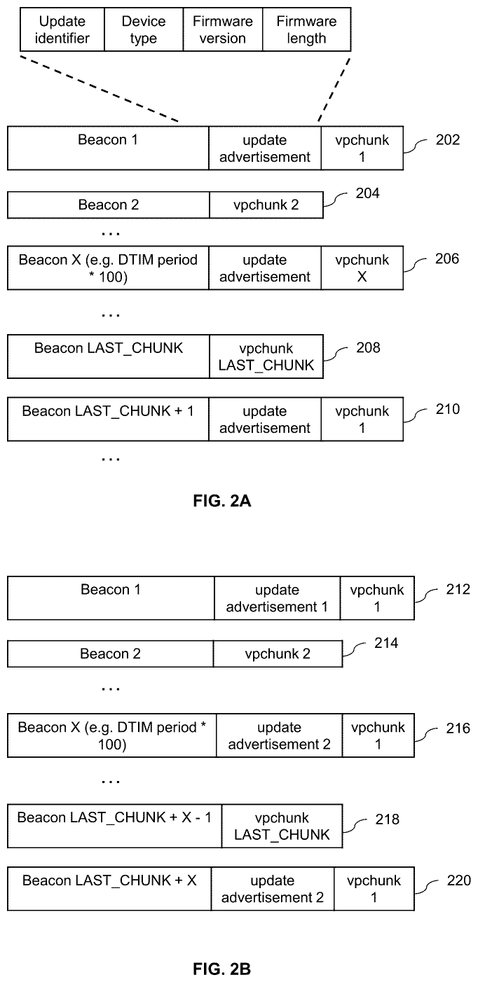

An embodiment of the update advertisement is present with the chunk, pchunk, or vpchunk in every predetermined management frame transmission. In another embodiment, the update advertisement is only present periodically, for example, every 100 predetermined management frames, to reduce the overhead of this infrequently changing information. FIG. 2A illustrates an embodiment of transmitting chunks of an update package using DTIM beacon frames and periodically transmitting an update advertisement in selected DTIM beacon frames. For example, the first DTIM beacon frame 202 consists of an update advertisement and a first chunk of the update package encapsulated in vpchunk 1, while some subsequent beacon frames, such as the second DTIM beacon frame 204, do not carry the update advertisement. In some embodiments, the update advertisement is transmitted in every X^{th} DTIM beacon period, for example, X is 100 in this embodiment. As shown in FIG. 2A, the 100^{th} DTIM beacon 206 transmits the update advertisement with the 100^{th} chunk (vpchunk X) of the update package. In one example, for beacon frames with a DTIM period value set to 4, implying there are 4 regular beacon frames between DTIM beacon frames, the update advertisement is inserted in every 100^{th} DTIM beacon frame, equivalent to every 500^{th} beacon frames. The entire update package may be retransmitted through another set of DTIM beacon frames after transmitting a complete cycle of chunks. As shown in FIG. 2A, the DTIM beacon frame 210 subsequent to the DTIM beacon frame 208 transmitting the last chunk (vpchunk LAST_CHUNK) carries the update advertisement and the first chunk (vpchunk 1) of the update package. Repeating update package transmission allows the STAs to receive the missing chunks.

Upon some changes to the firmware version, the update package and its update advertisement may be different from the one being transmitted as shown in FIG. 2B, a new update advertisement (update advertisement 2) indicates that a different firmware version is now being distributed. FIG. 2B illustrates another embodiment of periodically transmitting an update advertisement with a firmware version change during distribution of an update package. In this embodiment, the update advertisement (update advertisement 1) carried in the first DTIM beacon frame 212 advertises a firmware update with version 1, and the update advertisement is only transmitted in every X^{th} DTIM beacon frame, for example, X is 100. The second DTIM beacon frame 214 only carries the second chunk (vpchunk 2) of the update package without the update advertisement. In this embodiment, the firmware update changes from version 1 to version 2 before the AP broadcasts the next selected DTIM beacon frame 216, for example, the 100^{th} DTIM beacon frame (Beacon X). This DTIM beacon frame 216 then carries an update advertisement (update advertisement 2) indicating a firmware update with version 2, as well as the first chunk (vpchunk 1) of the new update package with firmware update version 2, to indicate to the STAs that a different firmware version is now being advertised. As shown in FIG. 2B, when the last chunk (vpchunk LAST_CHUNK) of the new update package is transmitted by the DTIM beacon frame 218 (Beacon LAST_CHUNK+X−1), transmission of the new update package with version 2 is completed. The chunks of this new update package may be transmitted again by inserting the first chunk (vpchunk 1) and the update advertisement 2 into the next DTIM beacon frame 220 (Beacon LAST_CHUNK+X).

The AP may send one or more chunks of the update package to all devices using the same predetermined management frame according to an embodiment. In another embodiment, the devices in the wireless network are categorized into various device types, and the AP sends one or more chunks of the update package to each device type using a different predetermined management frame. The update package for each device type may be slightly different or completely different from the update package for another device type. For example, the AP sends a chunk of the update package to devices belonging to device type 1 in every Nth beacon frame and sends a chunk to devices belonging to device type 2 in every Nth+1 beacon frame, and so on. N is a positive integer, which may be derived from the number of device types individually receiving the update package in the wireless network, for example, N is the number of device types plus 1. In some embodiment, the predetermined management frame is a DTIM beacon frame so the stations can operate in power save modes, such as a sleeping mode, during normal Traffic Indication Map (TIM) beacon frames and wake up every DTIM beacon frame to check the DTIM bit of the Bitmap control field of the TIM element and to receive the chunks of the update package. In an example, the AP sends an update package to stations of a selected device type using selected DTIM bacon frames, for example, sending a chunk to these stations in every Nth DTIM beacon frame.

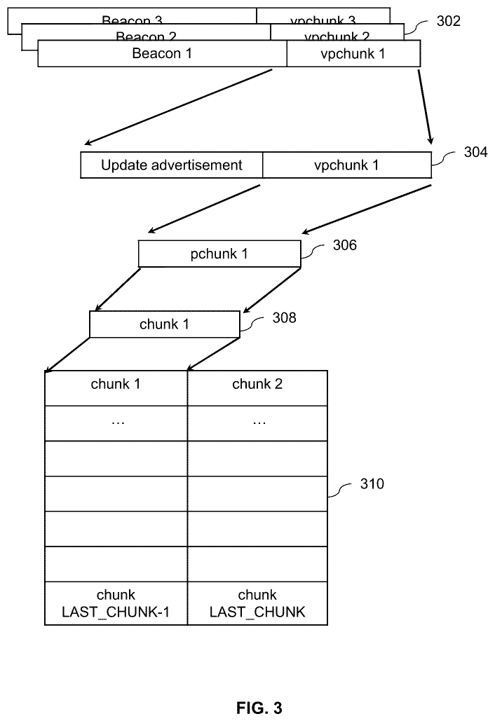

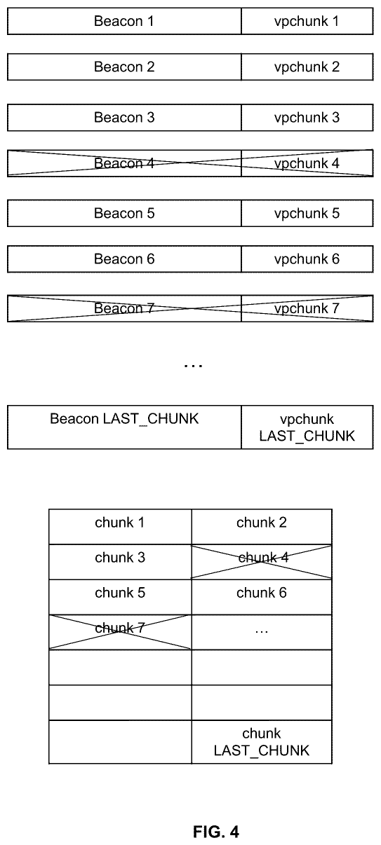

In an aspect of the present invention, a software program running on a STA obtains an update package through receiving multiple predetermined management frames from an AP in the wireless network. FIG. 3 illustrates the process performed in the STA after receiving a number of predetermined management frames carrying chunks of an update package in accordance with an embodiment of the present invention. The predetermined management frame is a beacon frame in this embodiment. An exemplary software program running on the STA begins in an idle state. A memory buffer 310 in the STA, called a chunk buffer, is used to store chunks of the update package extracted from the received beacon frames 302. One or more beacon frames 302 received by the STA also carry an update advertisement of the update package in this embodiment. The update advertisement may contain information of an update identifier, device type identifier, firmware version, and length of the update package or the firmware update. The STA is configured with an update filter based on the update advertisement present in at least one predetermined management frame according to this embodiment. For example, the update filter requires that the device type in the update advertisement matches a specific value and that the version number in the update advertisement is higher than the current firmware version. An embodiment of the STA receives a beacon frame consisting of an update advertisement and vpchunk 304, decapsulates a pchunk 306 from the vpchunk 304. The STA is configured to iterate through pchunks and update advertisement in the vendor IE. The STA may receive a beacon frame with a new update advertisement matching the device's update filter, and the new update advertisement invalidates the current in-progress firmware reception based on some comparison to the original update advertisement as shown in the example of FIG. 2B. For example, the STA detects a newer version of the firmware is now available and it can reset all states and start receiving chunks of the new update package again. Specifically, the software running in the STA resets any in-progress reception state, including invalidating the entire chunk buffer 310, resets the update filter based on the new update advertisement, and restarts the reception of vpchunks/pchunks/chunks to refill the chunk buffer 310. Otherwise, if a pchunk 306 whose corresponding update identifier matches the device's current update identifier value, the software running in the STA further decapsulates the firmware binary chunk 308 as shown in FIG. 3 and validates the signature if present. The STA stores the chunk 308 in the chunk buffer 310 according to the corresponding chunk offset, which is a part of the pchunk structure 306. In one embodiment, the STA further checks whether a chunk 308 with its chunk offset has been previously received, if so, the STA may simply discard the chunk 308, or it may validate this chunk against the previously received chunk with this chunk offset. From time-to-time, beacon reception may fail as shown in the example of FIG. 4, and holes may be seen in the chunk buffer of the STA. FIG. 4 illustrates an embodiment of a STA receiving beacon frame 1 to beacon frame LAST_CHUNK, each carrying a chunk of an update package from an associated AP. The STA receives each beacon frame, decapsulates a chunk of the update package from the beacon frame and stores the chunk in a chunk buffer. In this embodiment, the STA failed to receive beacon frame 4 and beacon frame 7, so there are holes in the chunk buffer corresponding to chunk 4 and chunk 7.

In an embodiment of the present invention, the chunk buffer size can be balanced against system capacity. At some time determined by the STA software, a larger block of chunks can be written into a predetermined flash location to allow reuse of the chunk buffer for reception of subsequent chunks according to this embodiment. In another embodiment, the entire firmware binary image can be received and reassembled into the flash memory over a number of beacon periods or a number of time periods measured by minutes, hours, or days.

Once the complete update package, for example, the entire firmware binary image, is received by the STA, the STA performs verification of the contents of the firmware binary image by running an authentication algorithm to verify the received firmware binary image. In some embodiments, the STA runs some forms of hash function across the entire firmware binary image, for example, the hash function is an md5 sum across the firmware binary image. In another example, the hash function is a cryptographically secure hash based on HMAC-SHA256, digitally signed by a private key on the AP side, the STA uses a public key to verify the HMAC-SHA256 hash. In yet another example, the hash function is a null operation, that is, there is no hash calculated across the firmware binary image. This may be done in cases where the firmware binary image within the chunk buffer itself is cryptographically signed and encrypted. The software program running on the STA then compares the hash generated from the received firmware binary image with that provided by the AP. In an embodiment, the AP-side hash is communicated via a special vpchunk with a unique chunk offset, for example, chunk offset 0xFFFF. In another embodiment, the AP-side hash is communicated through a periodic broadcast management action frame. In cases when the hash calculated on the STA side matches that provided by the AP, the STA will schedule an update of the firmware binary image at some point as determined by the STA, or as coordinated with the AP via some mechanism. For example, the STA or the AP coordinates the firmware update at some time when the STA is not in use, such as between sensor measurements, or outside some peak usage periods such as at 3 am in the morning.

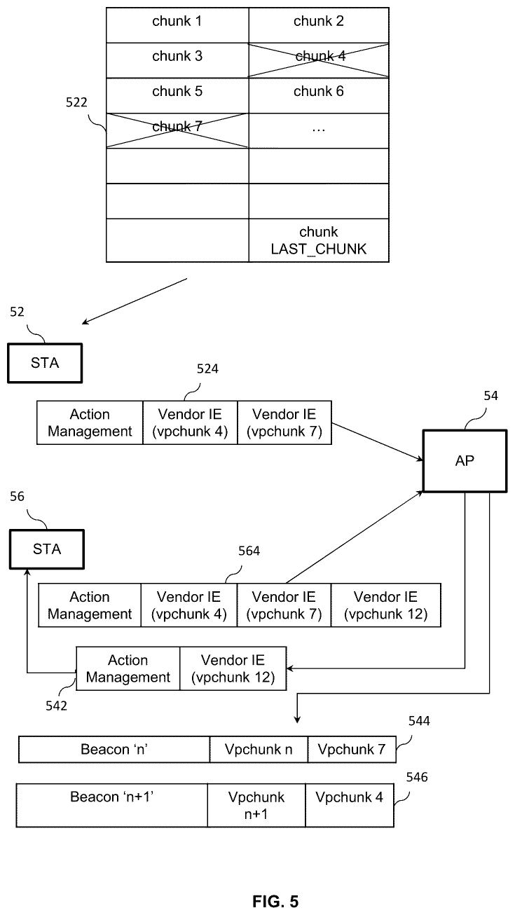

FIG. 5 illustrates STAs requesting missing chunks of an update package from an AP according to embodiments of the present invention. In some embodiments, the software program running on the STA 52 determines a list of missing chunks after receiving predetermined management frames carrying vpchunks corresponding to chunks between chunk 1 and chunk LAST_CHUNK, populates an action management frame 524 consisting of IDs of the list of missing chunks, and sends the action management frame 524 to the AP 54 as shown in FIG. 5. The STA 52 determines the list by checking if it has an incomplete firmware binary image stored in the chunk buffer 522, for example, the STA 52 checks whether there are one or more holes in the received image due to missed predetermined management frames and determines the chunk ID corresponding to each missing chunk. In another embodiment, the STA 52 may reach a certain threshold of missed chunks, which will then cause the generation and transmission of an action management frame 524 containing a list of missing chunk IDs. In yet another embodiment, the software program running on the STA 52 will simply monitor missed chunks and allow the natural cycling of the chunks transmitted from the AP 54 to the STA 52 to fill the holes.

The software program running on an AP may provide missing chunk services to the associated STAs. In some embodiments, the software program of the AP performs the following tasks: waiting for reception of action management frames including missing chunk information, receiving an action management frame from a STA, determining one or more missing chunks based on the received action management frame, and scheduling transmission of the missing chunk(s) from the AP to the STA. In an embodiment as shown in FIG. 5, chunk 4 and chunk 7 are missing from chunk buffer 522 of the STA 52, and the STA 52 sends an action management frame 524 containing two vendor specific IEs indicating the missing chunks are vpchunk 4 and vpchunk 7 to the AP 54. In some other embodiments, other encapsulated information fields can be used to convey the missing chunk information. In this embodiment, another STA 56 also sends an action management frame 564 to the AP 54, where the action management frame 564 contains three vendor specific IEs indicating the STA 56 has three missing chunks vpchunk 4, vpchunk 7, and vpchunk 12. The AP may immediately package up one or more missing chunks and send it by a single action management frame to the requesting STAs. Alternatively, the software program running on the AP waits a given time period to rebroadcast the missing chunks in subsequent predetermined management frames for delivering chunks or rebroadcast the missing chunks in broadcast management action frames. In this embodiment as shown in FIG. 5, upon receiving the action management frame 564, the AP 54 sends a directed action management frame 542 including one of the missing chunks vpchunk 12 to the STA 56. In this embodiment, the AP 54 determines some common chunks not delivered to more than one STA after receiving the action management frames from multiple STAs reporting missing chunks in the vendor IEs. For example, the AP 54 determines multiple STAs including STAs 52 and 56 failed to receive vpchunk 4 and vpchunk 7, instead of transmitting directed action management frames to each STA, the AP 54 broadcasts these missing chunks vpchunk 4 and vpchunk 7 through subsequent beacon frames 544 and 546. For example, one missing chunk vpchunk 7 is added to the subsequent beacon frame Beacon ‘n’ 544 carrying vpchunk n, and another missing chunk vpchunk 4 is added to Beacon ‘n+1’ 546 carrying vpchunk n+1. The STAs 52 and 56 receive these broadcast beacon frames 544 and 546 to extract these missing chunks vpchunk 7 and vpchunk 4 along with new chunks vpchunk n and vpchunk n+1.

In some embodiments, STAs can only request missing chunks after receiving a certain frame, for example, the AP sets a flag in a frame indicating the STAs are now allowed to request one or more missing chunks. This frame set by the AP may be a directed or broadcasted action management frame or it may be a directed or broadcast data frame. An embodiment of distributing an update package to a large number of STAs, the AP may use a pre-existing mechanism to divide the STAs into groups and only allow a group of STAs to request missing chunks at a time. For example, the AP may use a Restricted Access Window (RAW) mechanism to only allow a group of STAs with an Association Identifier (AID) in the range specified by the RAW IE of the beacon frame to request the missing chunks. The missing chunk(s) may be transmitted using the same type of predetermined management frames for transmitting chunks of the update package according to some embodiments, or the missing chunk(s) may be transmitted by a unicast method to one or more given STAs using a control frame, management frame, or data frame.

Various embodiments of the present invention for transmitting an update package for updating firmware can also be used to efficiently distribute files to a large quantity of devices wirelessly connected in the wireless network. The update package includes one or more files to be transferred to multiple STAs according to embodiments of the present invention, where the file can be segmented into chunks and transmitted by inserting one or more chunks into each predetermined management frame. The AP distributes the files to the STAs simultaneously by transmitting chunks of an update package containing the files through the predetermined management frames. For example, a STA receives a number of predetermined management frames carrying chunks of an update package and stores the chunks in a chunk buffer. In this embodiment, the STA also determines the chunk ID of each missing chunk and requests retransmission of the missing chunk by transmitting an action management frame to the AP. The STA extracts the chunks and constructs the files after receiving a complete update package. The files in this embodiment are not for firmware update, the step of scheduling firmware update after receiving the complete update package is omitted.

In some embodiments of distributing an update package through predetermined management frames, multiple device classes of devices can be simultaneously updated by an addition of vendor IEs (VIEs) specifying different device classes. This can be achieved through unique OUI vendor type and subtype fields. For example, the AP broadcasts a first update package to devices belonging to a first device class while broadcasts a second update package to devices belonging to a second device class. A chunk of the first update package and a chunk of the second update package may be inserted into the same predetermined management frame according to an embodiment. In another embodiment, each predetermined management frame only carries a chunk of the first update package or a chunk of the second update package.

Some embodiments of distributing an update package through predetermined management frames include inserting a unique update identifier (update ID) in the pchunk header for each update package. The challenge is keeping this update identifier small and unique. For example, each device could potentially be provisioned with a short “type” identifier that is specific to the class of device. This short type identifier would be included as part of the pchunk header and used by the device to filter only the pchunks intended for it. Similarly, a version number or hash could be included in the pchunk header, and when the value changes, the device resets its chunk buffer and starts again to collect chunks corresponding to this new version number.

In an embodiment of distributing an update package through predetermined management frames, type and version fields are consistent across multiple networks a device was provisioned to, the device is allowed to receive the update package across different networks.

An attacker could spoof a predetermined management frame, such as a beacon frame, by inserting a false or bad chunk. To prevent a bad actor sending predetermined management frames with invalid chunk of the update package for either a code injection or DoS through code injection, embodiments of the present invention also employ a protection mechanism for the predetermined management frames. In some embodiments, the predetermined management frames are guarded against the bad actor using an authentication algorithm, for example, the beacon frames carrying chunks, pchunks, or vpchunks are protected in the form of a Message Integrity Code (MIC), where the MIC is calculated over the contents of the beacon frame. In another embodiment, a crypto identifier is added to each meta-chunk, where a meta-chunk is a group of chunks, pchunks, or vpchunks. In yet another embodiment, each chunk is protected by a chunk signing key, and a signature that is truncated, for example, HMAC-SHA256 truncated to 16 bits, is added to the predetermined management frame for security reasons.

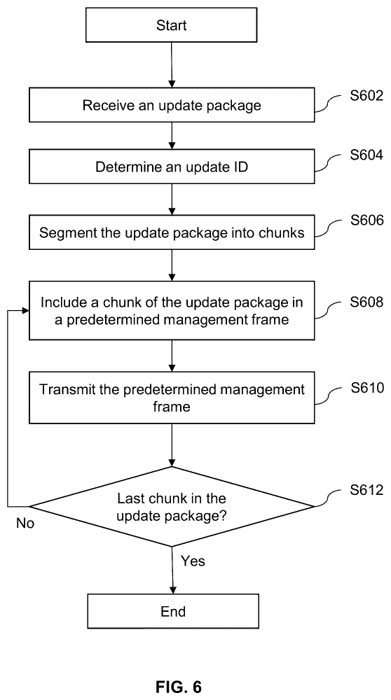

FIG. 6 is a flowchart illustrating a method of distributing an update package from a first device to one or more second devices according to an embodiment of the present invention. The first and second devices are wirelessly connected in a wireless network, and an example of the first device is an AP while an example of the second device is a STA associated to the AP. The method starts with the first device receiving an update package from a vendor to be distributed to the second device devices in step S602. The first device determines a unique update ID for the update package in step S604 and segments the update package into multiple chunks in step S606. In step S608, a chunk is inserted into a predetermined management frame, an example of the predetermined management frame is a beacon frame. The predetermined management frame carrying the chunk of the update package is directed transmitted or broadcasted to the second devices in step S610. The first device checks if the current transmitted chunk is the last chunk in the update package in step S612 and repeats steps S608 to S612 if it is not the last chunk.

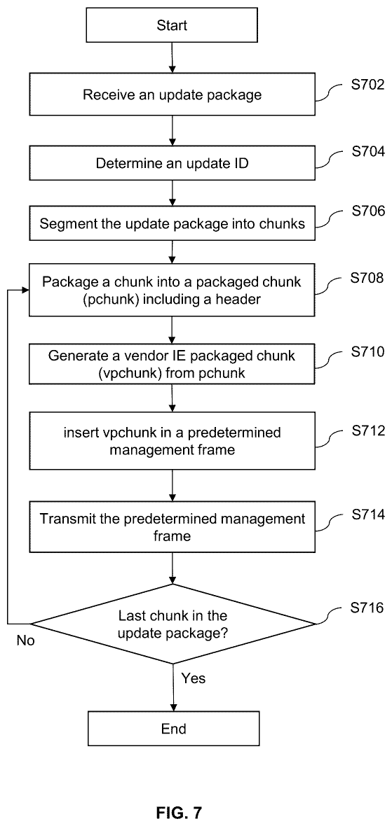

FIG. 7 is a flowchart illustrating a method of distributing an update package from a first device to one or more second devices according to another embodiment of the present invention. The first device receives an update package in step S702, determines an update ID for the update package in step S704, and segments the update package into multiple chunks in step S706. The method of FIG. 7 is similar to the method as shown in FIG. 6, except that the chunks of the update package are packaged into packaged chunks (pchunks) in step S708, then into vendor IE packaged chunks (vpchunks) in step S710 by inserting into a vendor IE. The pchunk contains a header including information such as a chunk offset. One or more vpchunks may carry an update advertisement including information such as a device type identifier, a firmware version, and/or a file length of the update package. The update ID may be included in one or both of the pchunk header and the update advertisement. The first device further inserts the vpchunk in a predetermined management frame in step S712 and transmits or broadcasts the predetermined management frame to the second devices in step S712. The first device determines whether the current chunk sent by the predetermined management frame is the last chunk in the update package in step S716 and repeats the steps from step S708 to step S716 if the current chunk is not the last chunk.

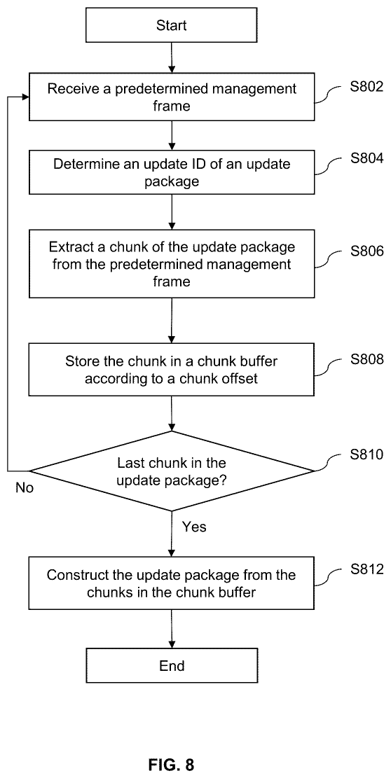

FIG. 8 is a flowchart illustrating a second device executing a method of receiving an update package through predetermined management frames from a first device according to an embodiment of the present invention. A predetermined management frame is received by the second device in step S802. The second device determines an update ID of the update package from the predetermined management frame in step S804. In another embodiment, the update ID is not present in all the predetermined management frames received by the second device, so step S804 may be skipped when receiving and processing a predetermined management frame not carrying the update ID. A chunk of the update package is extracted from the predetermined management frame in step S806 and the chunk is stored in a chunk buffer of the second device according to its chunk offset in step S808. The second device repeats steps S802 to S810 until receiving the last chunk of the update package. In step S812, the second device constructs the update package from the chunks in the chunk buffer. The second device schedules firmware update in cases of the update package consisting of a firmware update binary file.

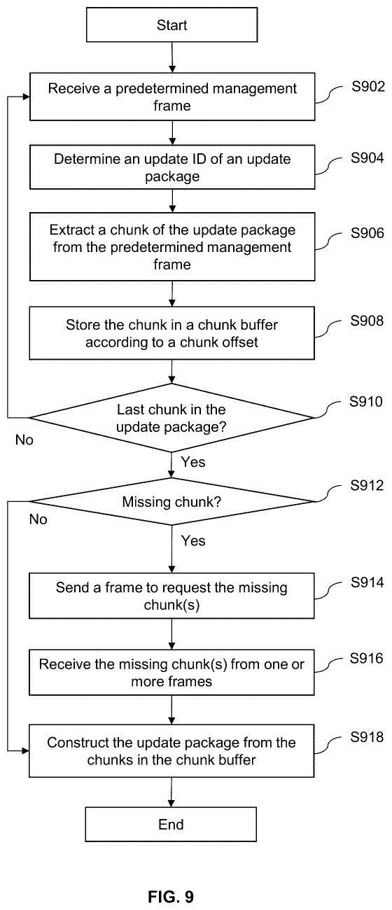

FIG. 9 is a flowchart illustrating a method of receiving an update package through predetermined management frames by a second device according to another embodiment of the present invention. The second device receives a predetermined management frame in step S902, determines an update ID of an update package in step S904. This step S904 may be skipped for some predetermined management frames as not all predetermined management frames carry the information of the update ID. A chunk of the update package is extracted from the received predetermined management frame in step S906, and it is stored in a chunk buffer according to a chunk offset in step S908. Upon receiving the last chunk of the update package in step S910, the method demonstrated in FIG. 9 further checks whether there is a missing chunk in step S912. If there is at least a missing chunk, the second device can send a frame to the first device to request the missing chunk(s) in step S914, else the update package is constructed from the buffered chunks in step S918. In step S916, the second device receives the missing chunk(s) from receiving one or more frames from the first device. The missing chunk(s) may be extracted from one or more action management frames, predetermined management frames, or any other frames received from the first device in the wireless network in accordance with various embodiments.

The above-mentioned methods of distributing an update package through predetermined management frames allow power efficient firmware update, file transfer, or data distribution, especially for large networks supporting a large number of client devices. The efficiency gain increases as the number of clients connected to one AP increases. The methods are standards-based extensions which are particularly beneficial in regions having a transmission duty cycle constraint. The duty cycle constraint limits the amount of airtime used by a device, and an AP implementing the present invention allows wide distribution of an update package while only impacting duty cycle constraint minimally.

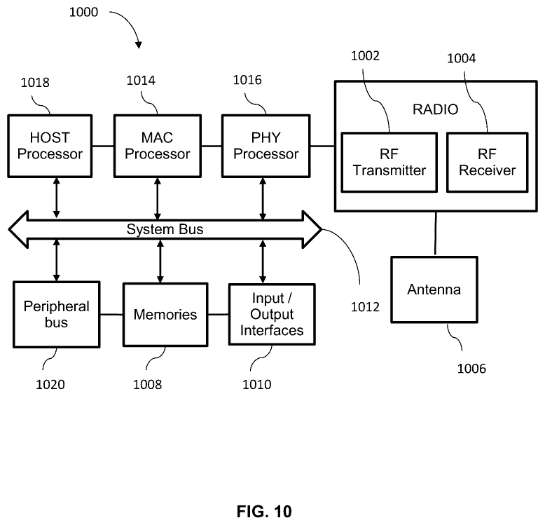

FIG. 10 illustrates an example of a device architecture of a communication device 1000 which can implement one or more file distribution methods or techniques described in the present invention. In some examples, the communication device is a mobile device, a wearable device, an extended reality device (e.g., a Virtual Reality (VR) device, an Augmented Reality (AR) device, or a Mixed Reality (MR) device), a personal computer, a laptop computer, a video server, a vehicle (or computing device of a vehicle), or other device wirelessly connected to a wireless network. The components of the communication device 1000 are shown in electrical communication with each other using connection 1012, such as a system bus. The communication device 1000 includes multiple processing units, Host processor 1018, MAC processor 1014, and PHY processor 1016, and the system bus 1012 that couples various communication device components including device memories 1008, such as Read Only Memory (ROM) and Random-Access Memory (RAM), to the processors 1018, 1014, and 1016. The system bus 1012 also coupled with input/output interfaces 1010, peripheral bus 1020, and a radio device including RF transmitter 1002 and RF receiver 1004. The radio device is coupled with an antenna 1006 for transmission and reception of radio signals.

To enable user interaction with the communication device 1000, input interface 1010 can couple to any number of input mechanisms, such as a microphone for speech, a touch-sensitive screen for gesture or graphical input, keyboard, mouse, motion input, speech and so forth. Output interface 1010 can also couple to one or more of a number of output mechanisms known to those of skill in the art, such as a display, projector, television, speaker device, etc. In some instances, multimodal computing devices can enable a user to provide multiple types of input to communicate with the communication device 1000. Input/Output interfaces 1010 can generally govern and manage the user input and device output. There is no restriction on operating on any particular hardware arrangement and therefore the basic features here may easily be substituted for improved hardware or firmware arrangements as they are developed.

Memories 1008 include a non-volatile memory and can be a hard disk or other types of computer readable media which can store data that are accessible by a computer, such as magnetic cassettes, flash memory cards, solid state memory devices, digital versatile disks, cartridges, RAM, ROM, and hybrids thereof. In one aspect, a hardware module that performs a particular function can include the software or processor readable codes stored in a computer-readable medium in connection with the necessary hardware components, such as PHY processor 1016, system bus 1012, input/output interfaces 1010, and so forth, to carry out the function.

Individual aspects may be described above as a process or method which is depicted as a flowchart or a data flow diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, or a subprogram. When a process corresponds to a function, its termination can correspond to a return of the function to the calling function or the main function.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above.

The program code may be executed by a processor, which may include one or more processors, such as one or more Digital Signal Processors (DSPs), general purpose microprocessors, an Application Specific Integrated Circuits (ASICs), Field Programmable Gate Arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices.

What is claimed is:

1. A method for file distribution to a plurality of devices in a wireless network, the method comprising:
determining an update identifier (ID) of an update package to be distributed to the devices in the wireless network;
segmenting the update package into a plurality of chunks;
for each chunk of the update package, including the chunk in a predetermined management frame; and
transmitting the predetermined management frames to the devices.

2. The method of claim 1, wherein the update package comprises a file and metadata for describing the file, and the metadata comprises one or both of a byte sequence used to uniquely identify a type of device receiving the update package and a version number of the file.

3. The method of claim 1, wherein the update package comprises a file and metadata, the metadata comprises the update ID of the update package, and the update ID is unique for a group of devices and is unique for each update package.

4. The method of claim 1, wherein the update package comprises a file and metadata, and the metadata comprises information about how often a chunk of the update package is included into a predetermined management frame.

5. The method of claim 1, wherein the update package comprises a file and metadata, and at least a portion of the metadata is inserted in every Nth predetermined management frame, wherein N is a positive integer.

6. The method of claim 1, wherein the update package comprises a file and metadata, and the metadata comprises a globally unique identifier for the update package that is synchronized across multiple networks, to allow a device moving between networks to resume the update package.

7. The method of claim 1, further comprising:
calculating a signature using an algorithm across at least a portion of the update package, wherein the signature is used to verify contents of the update package;
including the signature in the update package; and
transmitting the signature using one or more predetermined management frames or transmitting the signature independently through a frame.

8. The method of claim 1, further comprising assigning each chunk with a chunk offset representing an offset of the chunk within the update package, and packaging each chunk to include a header to generate a packaged chunk (pchunk), wherein the header comprises the chunk offset and the update ID.

9. The method of claim 1, further comprising generating an update advertisement for the update package, wherein the update advertisement is composed of one or a combination of the update ID, a device type identifier, a firmware version, and a file length.

10. The method of claim 9, wherein the step of including each chunk in a predetermined management frame further comprises inserting the update advertisement and the chunk in a vendor Information Element (IE) of the predetermined management frame or inserting only the chunk in a vendor IE of the predetermined management frame to generate a vendor IE packaged chunk (vpchunk).

11. The method of claim 1, wherein transmitting the predetermined management frames further comprises transmitting one or more chunks of the update package to device type 1 in every Nth predetermined management frame, and transmitting one or more chunks of the update package to device type 2 in every Nth+1 predetermined management frame, wherein N is a positive integer.

12. The method of claim 1, further comprising receiving a frame indicating one or more missing chunks of the update package from a Station (STA) in the wireless network, directly transmitting the one or more missing chunks through an action management frame to the STA or broadcasting the one or more missing chunks through a predetermined management frame.

13. The method of claim 1, further comprising broadcasting a frame with a flag set indicating requesting missing chunks is allowed.

14. A wireless communication device in a wireless network, comprising
a Radio Frequency (RF) receiver and an RF transmitter;
a processor, communicatively coupled to the RF receiver and the RF transmitter; and
one or more memory banks, communicatively coupled to the processor and storing processor readable codes that, when executed by the processor, is configured for:
determining an update identifier (ID) of an update package to be distributed to a plurality of devices in the wireless network;
segmenting the update package into a plurality of chunks;
for each chunk of the update package, including the chunk in a predetermined management frame; and
transmitting the predetermined management frames to distribute the update package to the devices in the wireless network.

15. A method for receiving an update package distributed in a wireless network, the method comprising:
wirelessly receiving a plurality of predetermined management frames;
determining an update identifier (ID) of the update package from at least one of the predetermined management frames;
extracting chunks of the update package from the predetermined management frames;
storing the chunks; and
constructing the update package from the chunks.

16. The method of claim 15, wherein one or more of the predetermined management frames comprise an update advertisement of the update package, and the update advertisement comprises one or a combination of the update ID, a device type identifier, a firmware version, and a length of the update package.

17. The method of claim 16, further comprising one or more of the following steps:
comparing the device type identifier in the update advertisement with a specific value;
and comparing the firmware version in the update advertisement with a current firmware version.

18. The method of claim 17, further comprising resetting an in-progress reception state and restarting again according to a comparison result of the firmware version in the update advertisement.

19. The method of claim 15, wherein storing the chunks further comprises checking a chunk offset of a chunk, and storing the chunk according to the chunk offset.

20. The method of claim 15, further comprising determining a signature of the update package, verifying contents of the update package according to the signature, and scheduling a firmware update when the update package is verified.

21. The method of claim 15, further comprising checking for any missing chunk of the update package, and requesting one or more missing chunks by transmitting a frame.

22. The method of claim 21, wherein requesting one or more missing chunks is performed after receiving a frame with a flag set indicating requesting missing chunks is allowed.

23. The method of claim 22, wherein the frame with a flag set indicating requesting missing chunks is allowed is a directed action management frame, a broadcast action management frame, a directed data frame, or a broadcast data frame sent by an Access Point (AP).
